(19) United States
(12) Patent Application Publication
(10) Pub. No.: US 2023/0379342 A1
(43) Pub. Date: Nov. 23, 2023

(54) SYSTEM AND METHOD FOR DETECTING MALICIOUS ACTIVITY BASED ON SET DETECTION

(71) Applicant: Wiz, Inc., New York, NY (US)

(72) Inventors: Itamar GILAD, Tel Aviv (IL); Aviel FOGEL, Tel Aviv (IL); Udi REITBLAT, Tel Aviv (IL); Alon SCHINDEL, Tel Aviv (IL); Ami LUTTWAK, Binyamina (IL); Roy REZNIK, Tel Aviv (IL); Yinon COSTICA, Tel Aviv (IL)

(73) Assignee: Wiz, Inc., New York, NY (US)

(21) Appl. No.: 18/361,366

(22) Filed: Jul. 28, 2023

Related U.S. Application Data
(63) Continuation-in-part of application No. 18/162,412, filed on Jan. 31, 2023.
Application No. 18/162,412 is a continuation-in-part of application No. 18/045,046, filed on Oct. 7, 2022.
(60) Provisional application No. 63/267,368, filed on Jan. 31, 2022.

(51) Int. Cl. H04L 9/40

(52) U.S. Cl. CPC H04L 63/1416; H04L 63/0263

(57) ABSTRACT

A system and method for reducing network communication from a sensor for detecting cybersecurity threats is disclosed. The method includes: configuring the resource to deploy thereon a sensor, the sensor configured to listen on a data link layer of the resource for an event; configuring the sensor to generate an event set from a plurality of events, based on a rule; detecting that a number of events in the event set exceeds a predetermined threshold; determining that a cybersecurity event occurred in response to detecting that the number of events exceeds the predetermined threshold; and initiating a mitigation action based on the cybersecurity event.

### CROSS-REFERENCE TO RELATED APPLICATIONS

This application is continuation in part of U.S. patent application Ser. No. 18/162,412 filed Jan. 31, 2023, which itself claims the benefit of U.S. Provisional Patent Application No. 63/267,368 filed on Jan. 31, 2022. This application is also a continuation in part of U.S. patent application Ser. No. 18/045,046 filed Oct. 7, 2022. All contents of these applications are hereby incorporated by reference.

### TECHNICAL FIELD

The present disclosure relates generally to detection of cybersecurity threats, and specifically to complementary solutions for cybersecurity threat detection utilizing static analysis and runtime data.

### BACKGROUND

Cybersecurity threats come in many shapes and forms, such as malware, worms, cryptominers, man-in-the-middle attacks, code injection, misconfigurations, and so on. Different threats pose different risks, and can often be detected in different ways. As such, there are many solutions which detect different types of cybersecurity threats, each with advantages and disadvantages. Cloud computing platforms, such as provided by Amazon® Web Services (AWS), Google® Cloud Platform (GCP), Microsoft® Azure, and the like, are high value targets for attackers, and therefore their vulnerabilities are more likely to become cybersecurity threats. It is therefore extremely useful to detect such cybersecurity threats.

For example, agent based solutions are able to detect both runtime and stored data, allowing to form a complete picture of the cybersecurity status of a machine having the agent installed thereon. However, agent based solutions require heavy use of compute resources, such as processor and memory resources. This is due to the agent being deployed on the machine which is scanned. For endpoints in a network, this type of solution is impractical, as the use of those resources is reserved for performing the task of the endpoint machine. Furthermore, some agent solutions also require communication with a backend which provides definitions, rules, and the like, in order to enable the agent to scan for cybersecurity threats using up to date information. Additionally, some agent based solutions require root privileges, or are deployed as a privileged software container. This in itself is a security risk, as conveying such permissions is inherently risky. Therefore, as an endpoint detection and response (EDR) solution for a cloud computing production environment, agent based solutions fail at their objective, and indeed such solutions are rarely used on network endpoints due to the above mentioned reasons.

Agentless solutions, on the other hand, do not require an agent installed on a machine. These solutions include static analysis, for example of a disk of a machine, to determine what cybersecurity threats are present. However, such solutions likewise fail at providing a complete picture, since static analysis solutions do not have access to runtime data. Such agentless solutions also fail to provide real time threat detection, thereby potentially leaving cybersecurity threats with a response for prolonged periods of time.

Utilizing both types of solution is not practical, as there is overlap in the data of agent and agentless solutions, and the computational costs of deploying both solutions on a single network are great. This leads, in practice, to a choice between either type of solution, with the resignation that some threats will inevitably go undetected.

Additionally, where runtime data is used the results can often be noisy, as machines tend to generate a lot of events, such as communication, packet transmission, changes in registry files, changes in configuration, and the like, all of which may be benevolent or may be benign.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a cloud computing environment monitored for a cybersecurity threat by an inspection environment, implemented in accordance with an embodiment.

FIG. 2 is a schematic illustration of a sensor backend server communicating with a plurality of sensors deployed on various workloads, implemented in accordance with an embodiment.

FIG. 3 is a flowchart of a method for performing cybersecurity threat detection on a resource in a cloud computing environment, implemented in accordance with an embodiment.

FIG. 4 is a schematic diagram of a sensor backend server according to an embodiment.

FIG. 5 is a flowchart of a method for mitigating a cybersecurity threat, implemented in accordance with an embodiment.

FIG. 6 is a flowchart of a method for utilizing a security graph in detecting a cybersecurity threat based on an indicator of compromise, implemented in accordance with an embodiment.

FIG. 7 is a flowchart of a method for reducing noise generation in detection of cybersecurity events.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for providing a sensor deployed on a workload in a cloud computing environment, to complement detection of cybersecurity threats using static analysis techniques. A sensor is a software package executable on a machine, such as an endpoint machine. An endpoint machine (or simply “endpoint”) may be, for example, a proxy, a gateway, a reverse proxy, a webserver, and the like. A sensor is able to deploy on an endpoint utilizing less resources than an agent, as the sensor is configured to retrieve and analyze less data than an agent software is. This is due to the sensor capabilities being complemented by a static analysis solution, such as a cybersecurity threat inspector.

In an embodiment, the sensor is configured to listen to a data link layer. For example, in an embodiment, a sensor is configured to listen for packets utilizing the extended Berkeley Packet Filter (eBPF) interface. In certain embodiments, the sensor is configured to request rules, definitions, and the like, from a sensor backend server. The sensor is configured, for example, to apply a rule from the requested rules, definitions, and the like to an event detected by listening on the eBPF interface of a machine on which the sensor is deployed. In certain embodiments, the sensor is configured to send an event to the sensor backend server, for example in response to determining that the event matches a predefined definition.

In an embodiment, the data link layer is also known as layer 2 of the OSI model of computer networking. In some embodiments, the data link layer is configured to transfer frames, which are containers for network packets. For example, Ethernet™, Frame Relay, PPP, USB, PCI Express, and the like, are protocols for data link layer communication. In TCP/IP, the data link layer is the lowest layer, known as the link layer.

In certain embodiments the sensor is configured to send an event, for example based on a predetermined definition, to a sensor backend server, which is configured to store the event on a security graph. The security graph includes a representation of the cloud computing environment in which the endpoint is deployed. For example, the sensor may detect that the endpoint sent a network packet to an IP address which is associated with a known cybersecurity risk, such as a coin mining pool. The sensor is configured to generate a notification to a sensor backend server. In an embodiment, the sensor backend server is configured to generate an instruction for an inspection controller. The inspection controller, in turn, is configured to provision an inspector to inspect the endpoint for the presence of a cryptominer malware.

By performing runtime and static analysis in this manner, the overlap in detection between the sensor and inspector are reduced. Additionally, the sensor is able to initiate inspection by the inspector, which allows efficient prioritizing of inspection resources, thereby reducing time to detection of cybersecurity threats, which also reduces time to respond to cybersecurity threats.

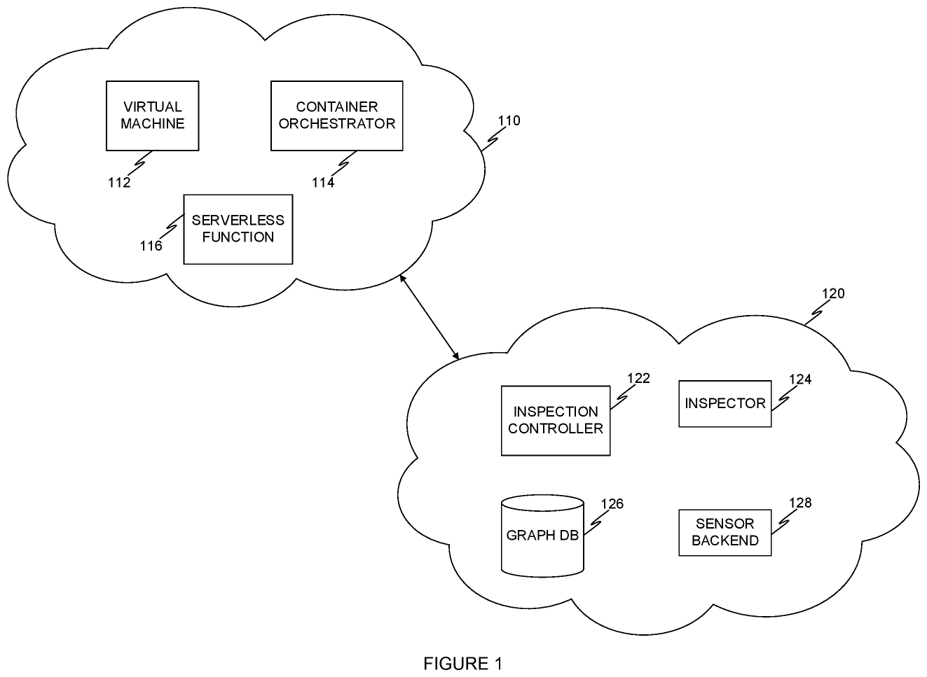

FIG. 1 is an example schematic diagram of a cloud computing environment monitored for a cybersecurity threat by an inspection environment, implemented in accordance with an embodiment. In an embodiment, a cloud computing environment 110 is implemented as a virtual private cloud (VPC), Virtual Network (VNet), and the like, over a cloud computing platform. A cloud computing platform may be provided, for example, by Amazon® Web Services (AWS), Google® Cloud Platform (GCP), Microsoft® Azure, and the like. A cloud computing environment 110 includes cloud entities deployed therein. A cloud entity may be, for example, a principal, a resource, a combination thereof, and the like. In an embodiment, a resource is a cloud entity which provides access to a compute resource, such as a processor, a memory, a storage, and the like. In some embodiments a resource is a virtual machine, a software container, a serverless function, and the like. A resource may be, or may include, a software application deployed thereon, such as a webserver, a gateway, a load balancer, a web application firewall (WAF), an appliance, and the like.

In certain embodiments, a principal is a cloud entity which is authorized to initiate actions in the cloud computing environment. A cloud entity may be, for example, a user account, a service account, a role, and the like. In some embodiments, a cloud entity is a principal relative to another cloud entity, and a resource to other cloud entities. For example, a load balancer is a resource to a user account requesting a webpage from a webserver behind the load balancer, and the load balancer is a principal to the webserver.

The cloud computing environment 110 includes a plurality of resources, such as virtual machine 112, software container orchestrator 114, and serverless function 116. A virtual machine 112 may be deployed, for example, utilizing Oracle® VirtualBox®. A software container orchestrator 114 may be deployed, for example, utilizing a Docker® engine, a Kubernetes® engine, and the like. In an embodiment, a software container orchestrator 114 is configured to deploy a software cluster, each cluster including a plurality of nodes. In an embodiment, a node includes a plurality of pods. A serverless function 116, may be, for example, utilized with Amazon® Lambda. In an embodiment, the serverless function 116 is a serverless function container image.

Each such resource is susceptible to various cybersecurity threats. Such threats can become apparent for example due to a software version of an application in a software container 114, an operating system (OS) version of a virtual machine 112, a misconfiguration in code of a serverless function 116, and the like. The cloud computing environment 110 is monitored for cybersecurity threats by an inspection environment 120. In an embodiment, the inspection environment is implemented as a cloud computing environment, such as a VPC, VNet, and the like.

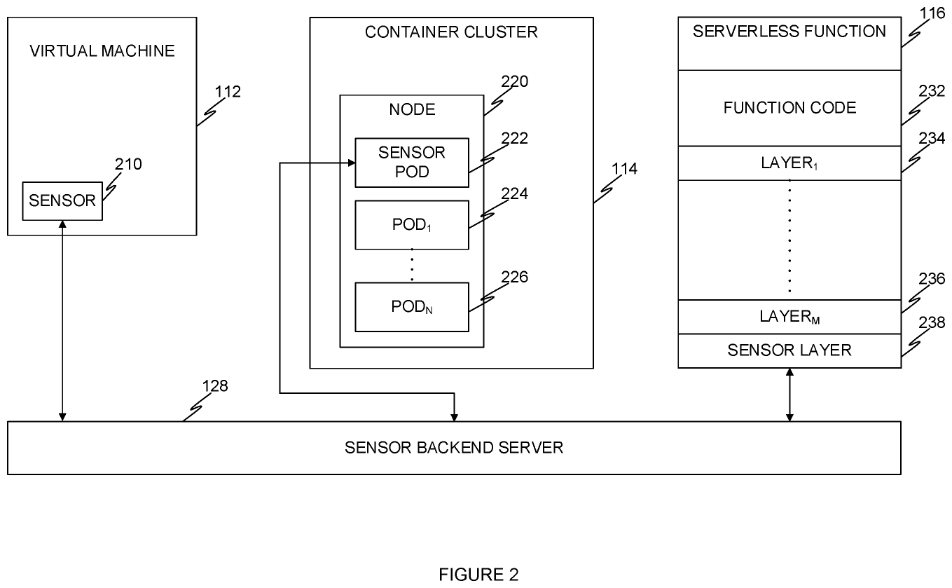

In an embodiment, each of the virtual machine 112, the software container 114, and the serverless function 116 include a sensor configured to a particular resource, resource type, combination thereof, and the like. An example deployment of a sensor is discussed in more detail in FIG. 2 below.

In an embodiment, the sensor (not shown in FIG. 1) is configured to listen for events, packets, and the like, on a data link layer. For example, the sensor is configured to utilize an eBPF interface, which allows non-intrusive monitoring of the data link layer communication. In certain embodiments, the sensor is further configured to send data to and receive data from a sensor backend server 128. The sensor backend server 128 is a workload, such as a virtual machine, software container, serverless function, combination thereof, and the like, which is deployed in the inspection environment 120.

In an embodiment, the sensor backend server 128 is configured to receive sensor generated data. For example, the sensor backend server 128 is configured, in an embodiment, to receive events from a sensor. In some embodiments, the sensor is configured to request from the sensor backend server 128 rules, definitions, and the like, which the sensor is configured to apply to events, for example as detected on an eBPF interface. For example, a predetermined event, such as indicating access to an IP address, IP address range, and the like, may be checked against a definition. A definition is a logical expression which, when applied to an event, yields a “true” or “false” result. In an embodiment, a rule is a logical expression which includes an action. For example, a rule may be that if a certain definition is true when applied to an event, data pertaining to the event should be sent to the sensor backend server 128.

In some embodiments, the sensor backend server 128 is configured to initiate inspection of a resource deployed in the cloud computing environment 110. For example, the sensor backend server 128 may be configured to initiate such inspection in response to receiving an event, data, a combination thereof, and the like, from a sensor deployed on a resource. In an embodiment, initiating inspection of a resource is performed by generating an instruction for an inspection controller 122. The instruction, when executed, configures an inspector 124 to inspect the resource.

For example, a sensor is configured to send event data to the sensor backend server 128 in response to detecting that a definition, applied by the sensor to a detected event, results in a “true” value when applied. As an example, the definition may be “is the IP address in the range of 127.0.0.1 through 127.0.0.99,” which in this example corresponds to an IP address range used by a malware, such as a cryptominer. When the definition is applied, for example to a detected network packet, and the result is “true,” the sensor is configured to send data pertaining to the event to the sensor backend server 128. Data pertaining to the event may be, for example, an IP address, an event type, combinations thereof, and the like.

In an embodiment, the sensor backend server 128 is configured to receive the data. In some embodiments, the sensor backend server 128 is further configured to apply a rule to the received data to determine if an inspection of the workload on which the sensor is deployed should be inspected for a cybersecurity threat. For example, the sensor backend server 128 is configured to generate an instruction to inspect a virtual machine 112, in response to receiving an indication from a sensor deployed as service on the virtual machine that a communication has been detected between the virtual machine 112 and a server having an IP address which is a forbidden IP address, such as an IP address associated with a malware.

For example, the sensor backend server 128 may generate an instruction for the inspection controller 122, which when executed by the inspection controller generates a an inspectable disk, for example utilizing a snapshot, a copy, a clone, and the like of a disk (not shown) associated with the virtual machine 112, and provides access to an inspector 124 to the inspectable disk. In an embodiment the inspector 124 is configured to detect a cybersecurity threat. For example, the inspector 124 is configured to receive, in an embodiment, a hash of an application stored on the inspectable disk, and determine if the hash matches a hash of known malware applications. In certain embodiments, the inspector 124 is provided with a persistent volume claim (PVC) to the inspectable disk.

In some embodiments, the sensor is configured to generate a hash of an application on the resource, such as the virtual machine 112, on which it is deployed, and send the hash to the sensor backend server 128. The received hash may then be compared, for example by providing it to the inspector 124, with known hash values which correspond to malware applications.

While the examples above discuss malware and cryptominers, it is readily apparent that the sensor and inspector 124 may be utilized to detect other types of cybersecurity threats, such as an exposure, a vulnerability, a weak password, an exposed password, a misconfiguration, and the like.

In certain embodiments, the inspection environment 120 further includes a graph database 126, on which a security is stored. In an embodiment, the security graph is configured to store a representation of a cloud computing environment, such as cloud computing environment 110. For example, the representation may be based on a predefined unified data schema, so that each different cloud platform may be represented using a unified data schema, allowing for a unified representation. For example, a principal may be represented by a predefined data structure, each principal represented by a node in the security graph. Likewise, a resource may be represented by another predefined data structure, each resource represented by a node in the security graph.

In certain embodiments, data received from a sensor deployed on a resource in the cloud computing environment may be stored in the graph database as part of the security graph. In the example above, in response to receiving data from the sensor which indicates a potential malware infection of the virtual machine 112, the sensor backend server 128 is configured, in an embodiment, to: generate a node representing the malware in the security graph, generate a node in the security graph representing the virtual machine 112, and connect the node representing the malware with the node representing the virtual machine 112.

FIG. 2 is an example schematic illustration of a sensor backend server communicating with a plurality of sensors deployed on various workloads, implemented in accordance with an embodiment. In some embodiments, a sensor backend server 128 is configured to communicate with a machine (not shown) having a sensor installed thereon and communicatively coupled with the sensor backend server 128. In an embodiment, the machine is bare metal machine, a computer device, a networked computer device, a laptop, a tablet, and the like computing devices.

In an embodiment, a sensor backend server 128 is implemented as a virtual machine, a software container, a serverless function, a combination thereof, and the like. In certain embodiments, a plurality of sensor backend servers 128 may be implemented. In some embodiments where a plurality of sensor backend servers 128 are utilized, a first group of sensor backend servers of the plurality of sensor backend servers is configured to communicate with a sensor deployed on a first type of resource (e.g., virtual machine), a second group of sensor backend servers is configured to communicate with resources of a second type, etc. In an embodiment, a first group of sensor backend servers is configured to communicate with sensors deployed on resources in a first cloud computing environment deployed on a first cloud platform (e.g., AWS) and a second group of sensor backend servers is configured to communicate with sensors deployed on resources in a second cloud computing environment deployed on a second cloud platform (e.g., GCP).

A virtual machine 112 includes a sensor 210. In an embodiment, the sensor 210 is deployed as a service executed on the virtual machine 112. In some embodiments, a virtual machine 112 is configured to request binary code, a software package, and the like, for example from a sensor backend sever 128, which when executed by the virtual machine 112 cause a sensor 210 to run as a service on the virtual machine 112. The sensor 210 is configured to listen to a data link layer communication, for example through an eBPF interface.

A container cluster 114 runs a daemonset, and includes a plurality of nodes, such as node 220. The daemonset ensures that each node 220 runs a daemonset pod 222, which is configured as a sensor. For example, a Kubernetes® cluster may execute a daemonset configured to deploy a daemonset pod on each deployed node, wherein the daemonset pod is configured to listen to a data link layer communication, for example through an eBPF interface, to communication of a plurality of pods, such as pod-1 224 through pod-N 226, where ‘N’ is an integer having a value of ‘1’ or greater. The daemonset pod 222 is configured, in an embodiment, to communicate with the sensor backend server 128.

A serverless function 116 includes, in an embodiment, a function code 232, and a plurality of code layers 1 through M (labeled respectively as 234 through 236), where ‘M’ is an integer having a value of ‘1’ or greater. For example, in AWS Lambda a layer contains, in an embodiment, code, content, a combination thereof, and the like. In some embodiments, a layer, such as layer 234 includes runtime data, configuration data, software libraries, and the like.

In certain embodiments, the serverless function 116 includes a sensor layer 238. The sensor layer 238 is configured, in an embodiment, to listen to a data link layer communication of the serverless function 116, for example through an eBPF interface.

The sensor service 210, daemonset pod 222, and sensor layer 238 are each an implementation of a sensor, according to an embodiment. In an embodiment, a sensor is configured to communicate with a sensor backend server 128 through a transport layer protocol, such as TCP. For example, the sensor backend server 128 is configured, in an embodiment, to listen to a predetermined port using a TCP protocol, and a sensor, such as sensor 210, daemonset pod 222, and sensor layer 238 are each configured to communicate with the backend sensor server 128, for example by initiating communication using TCP over the predetermined port.

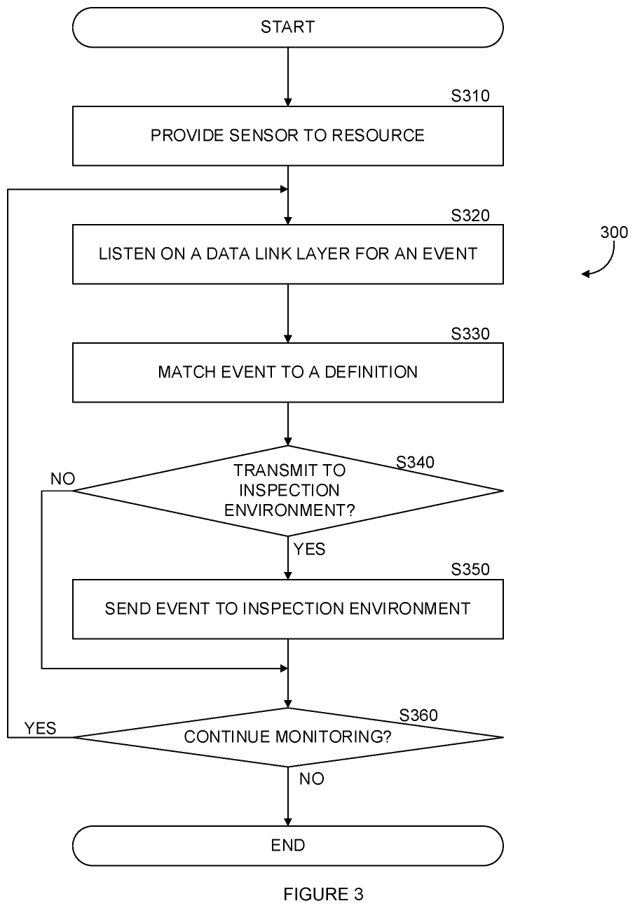

FIG. 3 is an example flowchart 300 of a method for performing cybersecurity threat detection on a resource in a cloud computing environment, implemented in accordance with an embodiment.

At S310, a resource is provided with a sensor software. In an embodiment, the resource is any one of a virtual machine, a software container, a serverless function, and the like. In certain embodiments, the sensor software is provided based on the resource type. For example, a virtual machine is provided with a software package, such as an executable code, for example a binary code. A software container engine is provided with a daemonset, so that, in an embodiment where a node is deployed in a cluster of the software container engine, the node includes a daemonset pod which is configured to provide the functionality of a sensor, for example such as detailed above. In an embodiment, a serverless function is provided with a sensor layer by providing a code for example in a .ZIP file.

In an embodiment, providing a sensor includes configuring a resource, such as a virtual machine, software container, serverless function, and the like, to receive software which, when executed, configures the resource to deploy a sensor thereon.

At S320, an event is detected from a data link layer communication. In an embodiment, the data link layer is monitored through an eBPF interface for events. In certain embodiments, a software bill of materials (SBOM) is generated. An SBOM may be implemented as a text file, which is based off of events which were detected, for example through the eBPF interface. In an embodiment, an SBOM includes an identifier of a library which is accessed in runtime, an identifier of a binary which is accessed in runtime, an image of which an instance is deployed in runtime, a port which is accessed by a runtime program, a cryptographic hash function value (such as an SHA1, SHA2, and the like values), and the like. For example, an SBOM may include:

```
programs {
  exe_name: “/usr/sbin/rpc.mountd”
  last_seen: 1663138800
  exe_size: 133664
  exe_sha1: “200f06c12975399a4d7a32e171caabfb994f78b9”
  modules {
    path: “/usr/lib/libresolv-2.32.so”
    last_seen: 1663138800
  }
  modules {
    path: “/usr/lib/libpthread-2.32.so”
    last_seen: 1663138800
  }
  modules {
    path: “/usr/lib/ld-2.32.so”
    last_seen: 1663138800
  }
  modules {
    path: “/usr/lib/libc-2.32.so”
    last_seen: 1663138800
  }
  modules {
    path: “/usr/lib/libtirpc.so.3.0.0”
    last_seen: 1663138800
  }
  modules {
    path: “/usr/lib/libnss_files-2.32.so”
    last_seen: 1663138800
  }
  modules {
    path: “/usr/sbin/rpc.mountd”
    last_seen: 1663138800
  }
  listening_sockets {
    ip_addr: “0.0.0.0”
    port: 60311
  }
  listening_sockets {
    ip_addr: “0.0.0.0”
    port: 43639
  }
```

This portion of an SBOM indicates that a remote procedure call (RPC) is executed, which is configured to receive a client request to mount a file system.

At S330, the event is matched to a definition. In some embodiments, a definition includes a logical expression, which when applied to an event results in a “true” or “false” value. For example, a definition may state “software library xyz is accessed,” with a result being either true or false, when applied to an event. In some embodiments, a rule is applied to an event. In an embodiment, a rule is a logical expression which further includes an action. For example, a rule states, in an embodiment, “IF software library xyz is accessed by UNKNOWN SOFTWARE, generate an alert.” In this example, where an event is detected in which a software having an unknown identifier, for example which does not match a list of preapproved identifiers, attempts to access software library xyz, an alert is generated to indicate that such access is performed.

At S340, a check is performed to determine if data should be transmitted to an inspection environment. In some embodiments, the check is performed by applying a rule to an event, and determining transmission based on an output of applying the rule. If ‘yes,’ execution continues at S350, if ‘no’ execution continues at S360.

At S350, data respective of an event is transmitted to an inspection environment. In an embodiment, the data is based on an SBOM file. In some embodiments, the data includes event data, such as an identifier of a resource (e.g., virtual machine, software container, serverless function, etc.), an identifier of an application, a hash value, a uniform resource locator (URL) request, a software library identifier, a software binary file identifier, a timestamp, and the like.

At S360, a check is performed to determine if monitoring of the resource should continue. For example, a daemonset of a container may be configured to periodically deploy a daemonset pod to monitor pods in a node. As another example, a virtual machine may be configured to periodically deploy a sensor service which runs as a process on the virtual machine, terminate the process after a predetermined period of time, terminate the process after a predetermined number of detected events, and the like. In some embodiments, the check is performed based on a predetermined amount of elapsed time (e.g., every four hours, every day, twice a day, etc.). If ‘yes,’ execution continues at S320. If ‘no,’ in an embodiment execution terminates. In some embodiments, if ‘no,’ another check is performed at S360, for example after a predetermined period of time has lapsed.

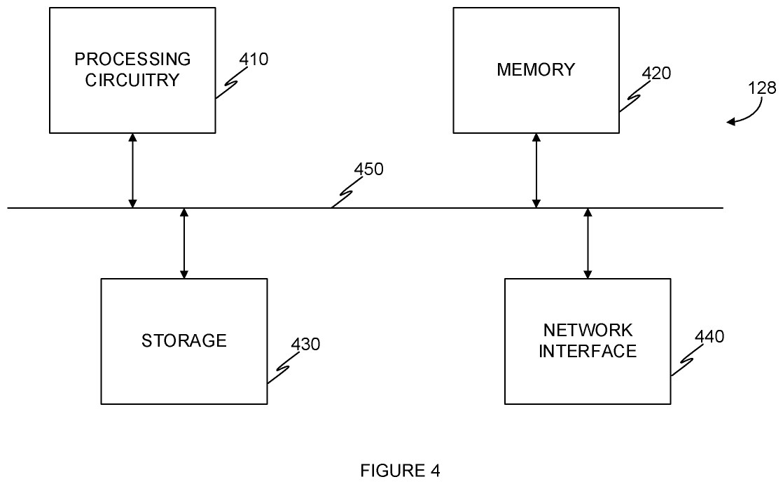

FIG. 4 is an example schematic diagram of a sensor backend server 128 according to an embodiment. The sensor backend server 128 includes a processing circuitry 410 coupled to a memory 420, a storage 430, and a network interface 440. In an embodiment, the components of the sensor backend server 128 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 440 allows the sensor backend server 128 to communicate with, for example, a sensor 210, a daemonset pod 222, a sensor layer 238, and the like.

It should be understood that the embodiments described herein are not limited to the specific architecture illustrated in FIG. 4, and other architectures may be equally used without departing from the scope of the disclosed embodiments.

Furthermore, in certain embodiments the inspection controller 122, inspector 124, and the like, may be implemented with the architecture illustrated in FIG. 4. In other embodiments, other architectures may be equally used without departing from the scope of the disclosed embodiments.

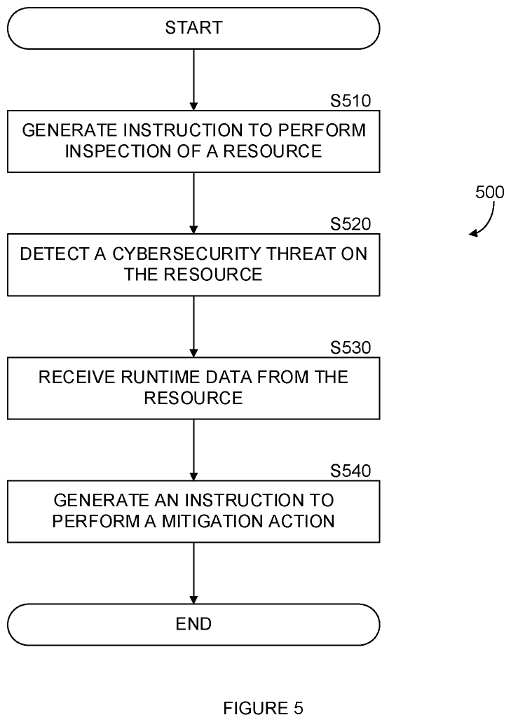

FIG. 5 is an example flowchart 500 of a method for mitigating a cybersecurity threat, implemented in accordance with an embodiment.

At S510, an instruction to perform inspection is generated. In an embodiment, inspection is performed on a resource, which may be, for example, a virtual machine, a software container, a serverless function, and the like. In an embodiment, the instruction, when executed, generates an inspectable disk based on a disk of a resource. For example, in an embodiment an inspectable disk is generated by performing a snapshot, a clone, a copy, a duplicate, and the like, of a disk attached to a virtual machine. The inspectable disk is accessible by an inspector. In an embodiment, the inspector utilizes static analysis techniques, for example to detect cybersecurity objects, such as a password, a certificate, an application binary, a software library, a hash, and the like.

The detected cybersecurity objects, cybersecurity threats, and the like, are represented, in an embodiment, in a security graph. For example, a node is generated in an embodiment to represent a malware object. The node representing the malware object is connected to a node representing the resource on which an inspector detected the malware object, to indicate that the malware object is present on the resource.

At S520, a cybersecurity threat is detected. In an embodiment, a cybersecurity threat is detected in response to detecting a cybersecurity object on a disk. In certain embodiments, a cybersecurity threat is an exposure, a vulnerability, a misconfiguration, a malware code object, a hash, a combination thereof, and the like. In some embodiments, a hash, which is detected or generated, is compared to another hash of a list of hashes which indicate know cybersecurity threats. For example, malware code objects are often detected by generating hashes of code objects and comparing them to hashes stored in a database of known hashes which are associated with malicious software. In certain embodiments, the cybersecurity threat is a potential cybersecurity threat. In an embodiment, runtime data is utilized to determine if the potential cybersecurity threat is an actual cybersecurity threat.

At S530, runtime data is received. In an embodiment, the runtime data is received from the inspected resource. In certain embodiments, runtime data is received based on cybersecurity objects detected by static analysis methods performed on the resource. For example, an inspector accessing an inspectable disk which is generated based on a disk of a virtual machine deployed in a cloud computing environment detects application libraries, which are cybersecurity objects. In an embodiment a definition is generated based on the detected cybersecurity objects. For example, a cybersecurity object may be a binary of application “xyz.” A definition is generated based on the detected cybersecurity object, for example “Application xyz is deployed in runtime.” In an embodiment, a rule is generated, for example based on the definition, further stating “IF application xyz is deployed in runtime, THEN perform mitigation action.”

At S540, an instruction to perform a mitigation action is generated. In an embodiment, the instruction, when executed, initiates a mitigation action in the cloud computing environment in which the resource is deployed. In some embodiments, the mitigation action is generated based on the detected cybersecurity threat and the received runtime data. In certain embodiments, the mitigation action includes generating an alert, assigning a severity score to an alert (e.g., low, moderate, severe, critical), modifying a severity score of an alert, and the like.

While static analysis techniques can detect such cybersecurity objects and threats, runtime data is required to determine if the cybersecurity objects and threats are actually present in runtime. For example, a database having a misconfiguration, such as no password protection, is considered a cybersecurity threat. Typically, an alert is generated in response to detecting such a cybersecurity threat, and a mitigation action is initiated. However, in cloud computing production environments many such alerts are generated, and therefore it is desirable to prioritize alerts based, for example, on a severity of an event. In this example, if a process for managing the database is not present at runtime, then the severity of the cybersecurity threat is actually lower than if the database software was running, and therefore presented an actual cybersecurity threat. It is therefore beneficial to combine static analysis data with runtime data in an efficient manner in order to prioritize responses, such as mitigation actions, to detected cybersecurity threats. This allows to better utilize the compute resources of a cloud computing environment, and improving response time to cybersecurity threats based on actual severity.

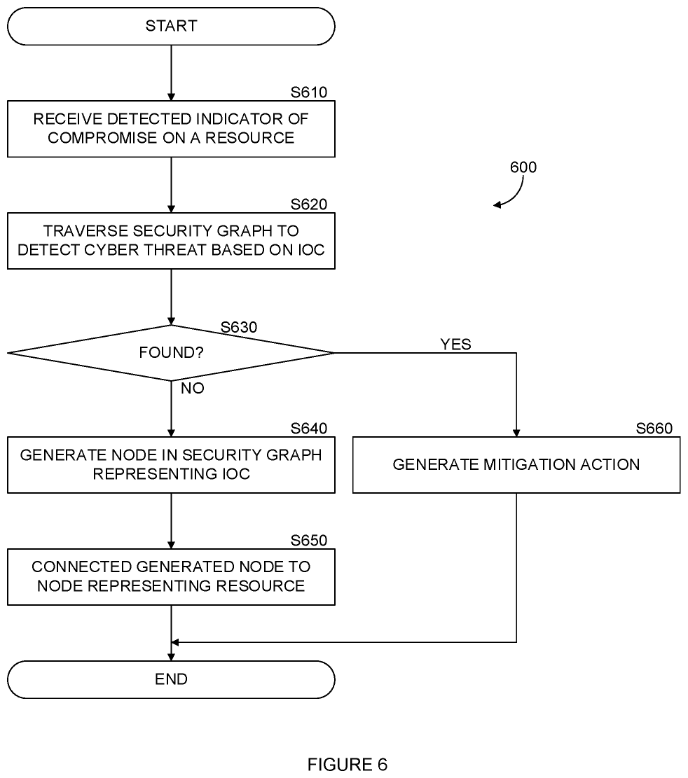

FIG. 6 is an example flowchart 600 of a method for utilizing a security graph in detecting a cybersecurity threat based on an indicator of compromise, implemented in accordance with an embodiment.

At S610, an indicator of compromise (IOC) is received. In an embodiment, the IOC is received from a sensor, the sensor configured to detect an IOC. In certain embodiments, an IOC is data, such as network traffic data, login data, access data, a data request, and the like. For example, IOC data indicates, in an embodiment, unusual network traffic, unusual login time, unusual logged-in user session time, a high volume of requests for data, network traffic to restricted domains, network traffic to suspicious geographical domains, mismatched port-application network traffic (i.e. sending command and control communication as a DNS request over port 80), and the like.

In certain embodiments, an IOC data is generated based on an aggregation of events detected on a resource, for example on a virtual machine. In an embodiment, a sensor is configured to store a plurality of events, and generate aggregated data based on the stored plurality of events. For example, network traffic destinations are stored, in an embodiment, to perform anomaly detection, i.e., to detect network traffic destinations which are anomalous.

At S620, a security graph is traversed to detect a cybersecurity threat. In an embodiment, an instruction is generated which, when executed by a graph database, configures a database management system to execute a query for detecting a node in a security graph stored on the graph database. In certain embodiments, the detected node represents a resource on which a sensor is deployed, the sensor generating the IOC data which is received at S610.

In certain embodiments, a security graph is traversed to detect a node representing a cybersecurity threat corresponding to the IOC and connected to a node representing the resource from which the IOC was generated. For example, a query is generated based on the IOC data and executed on the security graph. In an embodiment, execution of the query returns a result.

At S630, a check is performed to determine if the cybersecurity threat was found. In an embodiment, the check includes receiving a result from a query executed on a security graph, and determining if a node representing a resource is connected to a node representing a cybersecurity threat. If yes,′ execution continues at S660. If ‘no’ execution continues at S640.

At S640, a node is generated to represent the IOC in the security graph. In an embodiment, IOC data is stored with the node. In certain embodiments, an identifier of an IOC may be assigned to the IOC data, and the identifier of the IOC is stored with the node in the graph database.

At S650, an edge is generated to connect the node representing the IOC to a node representing the resource. In an embodiment the resource is a resource from which the IOC originated. For example, an edge may be generated to connected the node representing the IOC to the node representing the resource.

At S660, a mitigation action is generated. In an embodiment, generating a mitigation action includes generating an instruction which when executed configures a computing device to initiate the mitigation action. In an embodiment, the mitigation is initiating an inspection of the resource, generating an alert, a combination thereof, and the like. In certain embodiments the alert is generated based on any one of: the IOC data, an identifier of the resource, a predetermined rule, a combination thereof, and the like. In an embodiment, initiating inspection of a resource includes generating an instruction which when executed in a cloud computing environment configures the cloud computing environment to generate an inspectable disk, and provide an inspector workload access to the inspectable disk to inspect the inspectable disk for a cybersecurity threat corresponding to the IOC data.

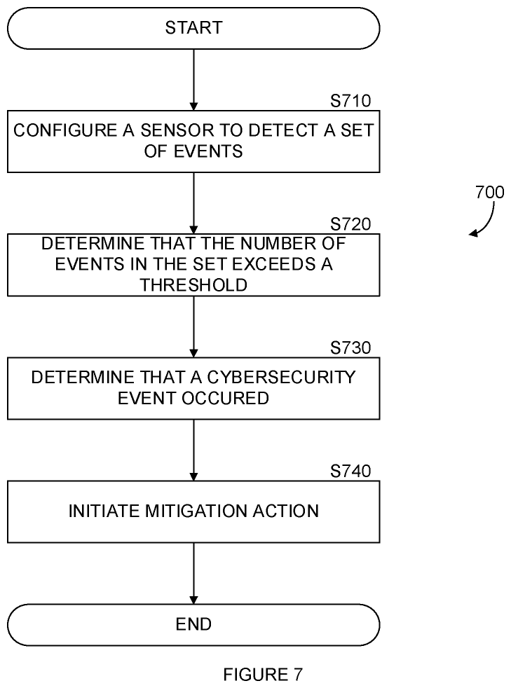

FIG. 7 is an example flowchart of a method for reducing noise generation in detection of cybersecurity events, implemented in accordance with an embodiment. In certain embodiments, a sensor detects many events, and sending them all to the sensor backend server is not practical as this requires to utilize a large amount of network resources in communication between the sensor and the sensor backend server, and further requires processing by the sensor backend server.

Often, many of these events are normal events for a machine to experience. For example, packet transmission is an event which is generally a normal type of event to occur (as a machine is required to interact with other machines, services, and the like in the computing environment), but can also indicate a cybersecurity problem. For example, where a large number of packets is suddenly sent to an external network, this indicates a cybersecurity issue, according to an embodiment.

It is therefore advantageous to reduce the overall “noise” generated by each sensor deployed on a resource in a computing environment, and it is further useful to determine what constitutes a cybersecurity event and what is normal operation for a particular machine. Accordingly, the method disclosed utilizes set detection based on the detected events.

At S710, an event set is detected. In an embodiment, a sensor deployed on a resource is configured to detect a plurality of events. In some embodiments, the sensor is configured to generate a set of events, for example by determining a set type, clustering event types, and the like. In some embodiments, the sensor is configured to generate an event set based on a predefined rule which is supplied to the sensor, for example from a sensor backend server.

In an embodiment, the resource is deployed in a cloud computing environment. For example, the resource is a software container node, including a plurality of pods. In an embodiment, an event set is generated, for example, to indicate data packets sent to a particular destination address.

In some embodiments, a sensor is configured to detect a plurality of events occurring on a virtual machine, a software container node, a serverless function, and the like, and transmit a portion of the plurality of events to the sensor backend server. This is advantageous as it reduces the amount of network bandwidth utilized in communication between the sensor and the sensor backend server. In certain embodiments, the sensor is further configured to detect an event set, and transmit information about the event set, without transmitting the entire set of events.

In certain embodiments, the sensor is configured to transmit a representative number of events from an event set. For example, according to an embodiment, the representative number is a predetermined number, a predetermined number based on the number of events in the event set, and the like.

In certain embodiments, event sets are requested from the sensor, for example based on detecting a vulnerability, exposure, misconfiguration, and the like, on the resource on which the sensor is deployed. In some embodiments, the sensor is configured to generate an event set based on certain types of events based on a detected vulnerability, exposure, misconfiguration, and the like. This is advantageous as only events which are indicative of exploitation of a particular cybersecurity threat are transmitted to the sensor backend server, thereby decreasing network utilization in the communication between the sensor and the sensor backend server. Furthermore, the number of events required to be processed by the sensor backend server is decreased, thereby reducing the processing requirements of the sensor backend server.

At S720, a number of events in the set is determined to exceed a threshold. In some embodiments, the threshold is based on an initial number of events in the set. For example, according to an embodiment, an event set includes a first number of events at a first time. A threshold is set for the event set, such that when the event set grows to double the number of events detected at the first time, the threshold is determined to be exceeded.

In some embodiments, the threshold is based on a rolling window of number of events.

For example, in an embodiment, the threshold is one hundred events over a rolling window period of one hour.

In certain embodiments, the threshold is determined by the event type. For example, according to an embodiment, a number of permission-based events which exceeds three events is indicative of a cybersecurity issue. According to another embodiment, a number of events indicating data packet transmission to a first destination which exceeds one thousand packets, exceeds the predetermined threshold.

In some embodiments, a compound threshold is determined for a plurality of sets. For example, in an embodiment, where a compound threshold includes a first threshold for a first event set, and a second threshold for a second event set. In such an embodiment, both thresholds must be crossed to determine that a cybersecurity issue has occurred.

For example, in an embodiment, a first threshold is set to one hundred packets to a first destination address, and a second threshold is set to two identity-based events. Each of these individually is not an indication for a cybersecurity event, but when both threshold are crossed this indicates a cybersecurity event.

At S730, a cybersecurity event occurrence is determined. In an embodiment, a cybersecurity event is determined to have occurred once a set size is determined to have exceeded a threshold. For example, in an embodiment, a sensor is configured to generate a set, e.g., based on a predetermined rule. Once a number of events in the set exceeds the threshold number, then a cybersecurity event is determined to have occurred, according to an embodiment.

In some embodiments, a second threshold number is determined, which is higher than the threshold number. In an embodiment, where the number of events exceeds the second threshold, a cybersecurity event occurrence is determined to not have occurred. In some embodiments, the determination is further based on a time frame, on a number of resources, on a number of compute clusters, a combination thereof, and the like. In certain embodiments, a number of events are further determined for a multi-tenant environment. This is advantageous, for example, where a single tenant has a number of events which do (or do not) indicate an event, but a plurality of events aggregated from a plurality of tenants do not (or do) indicate the event.

In certain embodiments, the sensor is configured to detect the number of events in a set of events. In some embodiments, the sensor is further configured to send information about the set, such as metadata of the event set, to a sensor backend server. For example, in an embodiment, a sensor is configured to send any one of: an indication that a set has exceeded a threshold number, the rule based on which the set was generated, at least a representative event of the set, a combination thereof, and the like.

By sending only the information about the set, rather than each of the events in their entirety, the amount of network bandwidth required for communication between the sensor and the sensor backend server is reduced. Furthermore, by configuring the sensor to generate the set, processing of the events is not required by the sensor backend server, thereby reducing the processing power needs thereof.

At S740, a mitigation action is initiated. In an embodiment, the mitigation action is initiated in response to determining that the number of events in a set exceeds a threshold. In some embodiments, the mitigation action is further generated based on the rule utilized to generate the set. In certain embodiments, the rule includes a conditional rule, for example, IF “event” HAS “destination address” ADD TO “dest_packet_set.”

In certain embodiments, the mitigation action includes any one of: generating an alert, generating a severity for an alert, generating a notification, generating an instruction to initiate cybersecurity inspection of the resource on which the sensor is deployed, revoking network access from the resource, revoking network access to the resource, sandboxing the resource, generating a ticket, generating a severity score for a ticket, updating a severity score of a ticket, a combination thereof, and the like.

In certain embodiments, the mitigation action includes configuring the sensor to detect a second type of event, a set of a second type of events, and the like. In some embodiments, the mitigation action includes adjusting a reporting threshold of the sensor, such that the sensor is configured to report more events, more events of a first type, a combination thereof, and the like. For example, in some embodiments, a sensor is configured to send a certain type of event only in response to detecting that an event set of another type (which is not the certain type) exceeds the threshold.

In certain embodiments, the sensor is assigned a memory portion of a workload on which it is deployed. In certain embodiments, the memory portion is utilized by the sensor as a buffer, including events stored in the buffer. In certain embodiments, the mitigation action includes sending the contents of the buffer, a portion of the contents of the buffer, and the like, for example to the sensor backend server.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for reducing network communication from a sensor for detecting cybersecurity threats, comprising:
configuring the resource to deploy thereon a sensor, the sensor configured to listen on a data link layer of the resource for an event;
configuring the sensor to generate an event set from a plurality of events, based on a rule;
detecting that a number of events in the event set exceeds a predetermined threshold;
determining that a cybersecurity event occurred in response to detecting that the number of events exceeds the predetermined threshold; and
initiating a mitigation action based on the cybersecurity event.

2. The method of claim 1, further comprising:
generating the event set based on detecting a group of events having a common event type.

3. The method of claim 1, further comprising:
sending information of the event set in response to determining that the cybersecurity event occurred.

4. The method of claim 3, further comprising:
sending a representative event from the event set.

5. The method of claim 3, further comprising:
sending the rule based on which the event set was generated.

6. The method of claim 1, further comprising:
configuring the sensor to detect an event of a second type, in response to determining that the cybersecurity event occurred.

7. The method of claim 1, further comprising:
detecting an event of a first type; and
generating a rule to generate an event set based on the first type.

8. The method of claim 7, further comprising:
deleting the generated rule, in response to determining that the event set based on the first type includes a number of events which is below a first threshold.

9. The method of claim 1, further comprising:
detecting that a number of events in a second event set exceeds a second predetermined threshold; and
determining that the cybersecurity event occurred in response to detecting that the number of events exceeds the predetermined threshold, and the number of events in the second event set exceeds the second predetermined threshold.

10. The method of claim 1, further comprising:
determining that the cybersecurity event did not occur in response to detecting that the number of events exceeds a second predetermined threshold which is higher than the predetermined threshold.

11. The method of claim 1, further comprising:
detecting events from a plurality of resources, each resource having a sensor deployed thereon;
determining that the cybersecurity event did not occur in response to detecting that a number of events aggregated from the plurality of resources exceeds a threshold.

12. A non-transitory computer-readable medium storing a set of instructions for reducing network communication from a sensor for detecting cybersecurity threats, the set of instructions comprising:
one or more instructions that, when executed by one or more processors of a device, cause the device to:
configure the resource to deploy thereon a sensor, the sensor configured to listen on a data link layer of the resource for an event;
configure the sensor to generate an event set from a plurality of events, based on a rule;
detect that a number of events in the event set exceeds a predetermined threshold;
determine that a cybersecurity event occurred in response to detecting that the number of events exceeds the predetermined threshold; and
initiate a mitigation action based on the cybersecurity event.

13. A system for reducing network communication from a sensor for detecting cybersecurity threats comprising:
a processing circuitry; and
a memory, the memory containing instructions that, when executed by the processing circuitry, configure the system to:
configure the resource to deploy thereon a sensor, the sensor configured to listen on a data link layer of the resource for an event;
configure the sensor to generate an event set from a plurality of events, based on a rule;
detect that a number of events in the event set exceeds a predetermined threshold;
determine that a cybersecurity event occurred in response to detecting that the number of events exceeds the predetermined threshold; and
initiate a mitigation action based on the cybersecurity event.

14. The system of claim 13, wherein the memory contains further instructions which when executed by the processing circuitry further configure the system to:
generate the event set based on detecting a group of events having a common event type.

15. The system of claim 13, wherein the memory contains further instructions which when executed by the processing circuitry further configure the system to:
send information of the event set in response to determining that the cybersecurity event occurred.

16. The system of claim 15, wherein the memory contains further instructions which when executed by the processing circuitry further configure the system to:
send a representative event from the event set.

17. The system of claim 15, wherein the memory contains further instructions which when executed by the processing circuitry further configure the system to:
send the rule based on which the event set was generated.

18. The system of claim 13, wherein the memory contains further instructions which when executed by the processing circuitry further configure the system to:
configure the sensor to detect an event of a second type, in response to determining that the cybersecurity event occurred.

19. The system of claim 13, wherein the memory contains further instructions which when executed by the processing circuitry further configure the system to:
detect an event of a first type; and
generate a rule to generate an event set based on the first type.

20. The system of claim 19, wherein the memory contains further instructions which when executed by the processing circuitry further configure the system to:
delete the generated rule, in response to determining that the event set based on the first type includes a number of events which is below a first threshold.

21. The system of claim 13, wherein the memory contains further instructions which when executed by the processing circuitry further configure the system to:
detect that a number of events in a second event set exceeds a second predetermined threshold; and
determine that the cybersecurity event occurred in response to detecting that the number of events exceeds the predetermined threshold, and the number of events in the second event set exceeds the second predetermined threshold.

22. The system of claim 13, wherein the memory contains further instructions which when executed by the processing circuitry further configure the system to:
determine that the cybersecurity event did not occur in response to detecting that the number of events exceeds a second predetermined threshold which is higher than the predetermined threshold.

23. The system of claim 13, wherein the memory contains further instructions which when executed by the processing circuitry further configure the system to:
detect events from a plurality of resources, each resource having a sensor deployed thereon; and
determine that the cybersecurity event did not occur in response to detecting that a number of events aggregated from the plurality of resources exceeds a threshold.
